(19) United States
(12) Patent Application Publication
(10) Pub. No.: US 2008/0288978 A1
(43) Pub. Date: Nov. 20, 2008

(54) Nut Cracker

(76) Inventors: Douglas Sundberg, Billingsfors (SE); Linah Glimmersten, Bengtsfors (SE)

Correspondence Address: MANELLI DENISON & SELTER, 2000 M STREET NW SUITE 700, WASHINGTON, DC, 20036-3307, US

(21) Appl. No.: 11/629,348

(22) PCT Filed: Jun. 12, 2005
(86) PCT No.: PCT/SE05/00937

§ 371 Date: Dec. 12, 2006

Related U.S. Application Data
(60) Provisional application No. 60/579,685, filed on Jun. 16, 2004.

(51) Int. Cl. G06F 13/00

(52) U.S. Cl. 725/38

(57) ABSTRACT

A method of providing selectable interactivity for a viewer watching a show, whereby the viewer (1) can choose a position or person (6) from which the viewer will experience audio from the ongoing show, the viewer (1) being informed of a given code (K1) arranged by a certain activity to provide said selectable audio from the show.

### TECHNICAL FIELD

The present invention relates to a method of providing selectable interactivity for a viewer watching a show, whereby the viewer can choose a position or person from which the viewer will then experience audio from the ongoing show. The invention also relates to a system.

### PRIOR ART

It is widely known that interactive television watching has been coming for some time to the world of media Obviously, there is a demand for different possibilities for televiewers to partake more actively in the show. So far, we have not seen any radical changes in practice, but a variety of concepts have been suggested.

It is known for example from WO 96/21321 to provide a system that allows for virtual interactivity for a televiewer, such that the televiewer may choose a particular position/person from which the televiewer will experience both video and audio. A very complex technique is required in order to enable such virtual possibilities, and this is likely the main reason for the system not yet being available on the market, at least not to any appreciable extent.

WO 94/13107 describes another type of interactive television system, which is also based on advanced techniques and accordingly is costly, which is likely the reason for this system not having penetrated the market.

A system that is possibly somewhat less complex is known from U.S. Pat. No. 6,397,388, WO 02/30120, WO 02/30121, WO 02/30129, WO 02/096111 and WO 03/028373, which system is however not primarily intended to allow for any real interactivity, but instead enables a kind of teleconference via the television system, for viewers at different locations, such that despite the distance they may communicate during televiewing in order to achieve a sense of community. Also this system is however based on a special technology, a set top box, intended to handle the conference functionality, as well as a remote control intended to include a microphone and a calling function.

In common for all systems described above, is that they require purchasing of more or less costly extra equipment/technology, and that they are fairly complex in order to provide interactivity for the televiewer.

### Brief Account of the Invention

It is an object of the present invention to eliminate or at least minimize the above mentioned problems, which is achieved by a method of providing selectable interactivity for a viewer watching a show, whereby the viewer may choose a position or person from which the viewer will then experience audio from the ongoing show, characterised in that the viewer is informed of a given code arranged by a certain activity to provide said selectable audio from the show.

The invention enables a surprisingly simple way of achieving interactivity for a viewer, such as a televiewer, by the method allowing use of already existing technology. In other words, the invention allows the possibility of interactivity for the televiewer, without having to buy additional specific technology. It should be mentioned in this connection however that the invention does not rule out that for certain applications, and certain embodiments, there might be a need of purchasing additional technology, for example in order to achieve improved interactivity or a specific type of interactivity.

According to further aspects of the invention:
said viewer is a televiewer, and said show is a television program, which is particularly beneficial since the infrastructure for this type of interactivity is available practically everywhere, without need of supplementary technology,
said code is presented to the televiewer on the television screen, preferably simultaneously with the broadcasting of the television program for which the selectability exists, which is beneficial from the viewpoint that existing infrastructure/technology can be achieved thereby,
said code is arranged to be communicated to an ordering unit via the telephone, which is a particularly easy of access solution since various types of telephones are in principle more common than television sets.
said code is a telephone number, enabling direct establishing of a connection via the telephone system's audio transfer, i.e. in principle without need of other adjustments,
a plurality of such selectable codes are shown, in order to provide selectability of different specific audio choices, enabling the client to make his own choices completely according to his own wishes.
said selectable service is associated with a time-dependent cost, preferably including a minute per minute cost, which also means employment of technology that is in principle already known, and allows for a simple and convenient possibility for the client to have some control of the costs that follow,
at least one of said codes is dedicated a given individual who partakes in the show, providing the advantage that the viewer/client need not be aware of the position of the individual on whom he wishes to listen,
at least one code is dedicated at least one given position associated with the show, providing the advantage that the viewer can experience audio from a specific position independent of which actors that are present at that location.

According to preferred embodiments, the same advantages and aspects may in principle be arranged for in connection with the system. Additional advantages of the invention will be obvious from the following detailed description.

### BRIEF DESCRIPTION OF THE DRAWINGS

In the following, the invention will be described with reference to the enclosed drawings that in greater detail disclose some embodiments of the invention, whereby:

FIG. 1 schematically shows a preferred embodiment of the invention in connection with a person using the interactivity according to the invention,

FIG. 2 shows an alternative embodiment particularly suitable for several televiewers using the same television set,

FIG. 3 shows a third alternative embodiment in use of the invention, and

FIG. 4 shows a modified embodiment for use of the concept according to the invention.

### DETAILED DESCRIPTION

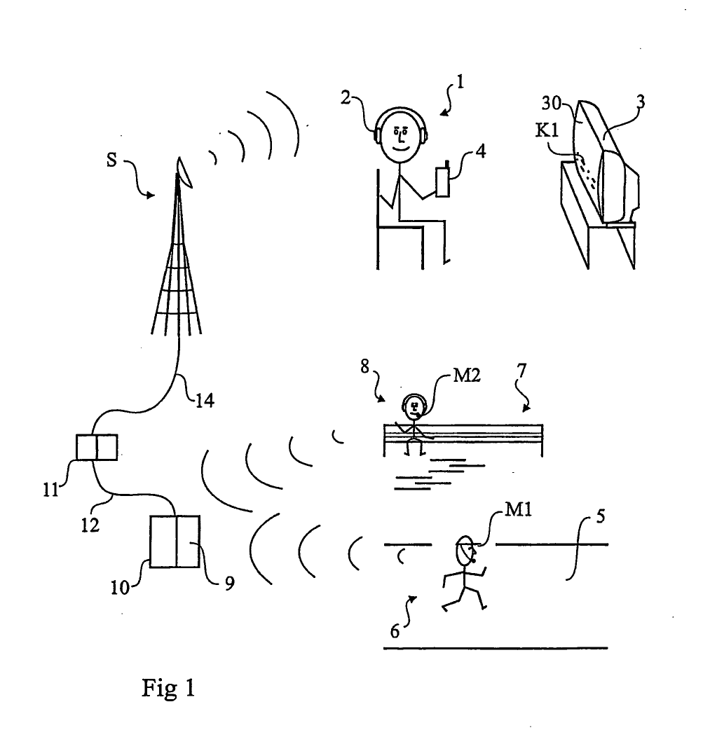

FIG. 1 schematically shows a preferred embodiment according to the invention. A televiewer 1 is shown in front of a television set 3. The televiewer has a telephone 4 provided with head phones 2. The screen 30 of the television set 3 shows a sports match in live broadcasting (which is well known per se), taking place a great distance from the televiewer 1. Simultaneously with the match (and/or in advance), the television screen 30 shows codes Kn, in this case being telephone numbers. Each code is specifically dedicated to a given microphone Mn. A number of players 6 (only one being shown here) are on the sporting ground 5 for the match shown on television 3, and in some cases also commentators provided with microphones M. In the present case, American football is shown, and the quarterback 6 of one of the teams is provided with a first microphone M1. A commentator 8 equipped with a second microphone M2 is on the stand 7. The microphones M1, M2 transmit audio signals, preferably all the time during the match, to a receiver 9 that by hardware and software known per se is able to separate and specially treat each one of the incoming transmitting signals. By suitable software and hardware 10, known per se, the received signals are transmitted, e.g. via a fixed connection 12, to a type of transmitting central/switch unit 11. This central/unit 11 contains hardware and software known per se, in order to forward audio from a chosen audio source Mn to a specific client 1.

In the shown case, the televiewer 1 wants to listen to the audio from the quarterback 6. By aid of his telephone 4, the televiewer 1 dials the telephone number K1 dedicated to the quarterback 6. This information is received and treated by the transmitting central/switch unit 11 that via a suitable connection 14 (such as a fixed connection to a transmitter S) transmits the chosen audio signal to the telephone 4, whereby a real time connection is established to the microphone M1 carried by the quarterback 6. The viewer 1 will now, in his head phones 2 and in real time, experience the exact audio received by the microphone M1 carried by the quarterback 6. According to a preferred embodiment, this interactive service is priced in relation to time of use, meaning e.g. that the viewer 1 has to pay SEK 50: - per minute of connection. Accordingly, the viewer 1 chooses himself exactly who he wants to listen to, by dialling the desired code Kn shown on the screen of the television set 3, and also he chooses for how long he wants to enjoy the interactive listening, i.e. how much it is allowed to cost.

It is realised that many modifications can be made within the scope of the invention. Accordingly, it is realised that the microphone M1 need not be positioned on the player 6, but that it very well can be the case that someone is standing next to the playing ground with a directional microphone following the player 6. It may also be desirable in some cases instead of following a particular player 6, or commentator 8, to listen to the audio from a specific position, e.g. by a microphone listening in to the audio in front of the goal-circle of an ice-hockey rink It is also realised that the method is suitable for use for all types of live shows, and in fact also for non-live broadcasts, in which case the audio must be stored separately and synchronised with the broadcast. It is also realised that the hardware and software 9, 10 of the receiver can be widely varied, since many types of techniques can be used for receiving according to the concept of the invention. Furthermore, it is realised that many types of transmitting means can be used to transmit audio, or audio packages, from the receiver 9, 10 to the switch unit 11, such as different types of known wireless transmissions. It is also realised that digital transmission is most preferred from many viewpoints, but that analogue techniques also can be used. Furthermore, it is realised that the televiewer's 1 telephone 4 naturally can be connected for wireless communication or fixed communication.

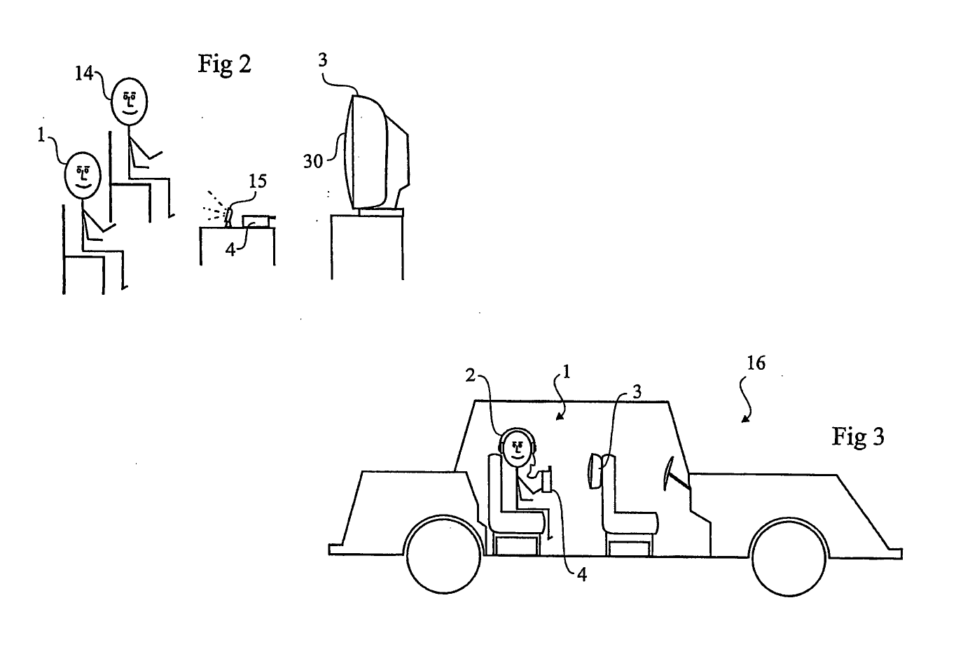

Another modification according to the concept of the invention is that the code K1 is adapted also to be able to choose the audio source via a PC that e.g. is connected via broadband, in which case the code K1 need not be a telephone number. It is also realised that an optional choice for the televiewer 1 is either to choose to have the general audio of the broadcast active, or to shut off the audio from the television set and only to listen to the specifically chosen audio stream. In particular in connection with the case in which the audio stream is taken in via a PC, it may be advantageous to have the audio from the television shut off, since many PCs of today are equipped with a more advanced audio system than the television set. FIG. 2 shows a variant of that in FIG. 1, showing that more than one televiewer 1, in this case two persons 1, 14, can choose to listen to the same selectable audio source. The principles of choosing the selectable audio stream are the same in FIG. 2 as that shown in FIG. 1. It is however shown that the televiewers 1, 14 make use of a loudspeaker 15, in this case connected to the telephone 4, in order to be able to listen in to the same audio source. Accordingly, the two televiewers 1, 14 can both listen to exactly the same interactive audio experience, via the loudspeaker 15. Also in this case, either fixed and mobile technology can be used to realise the interactivity.

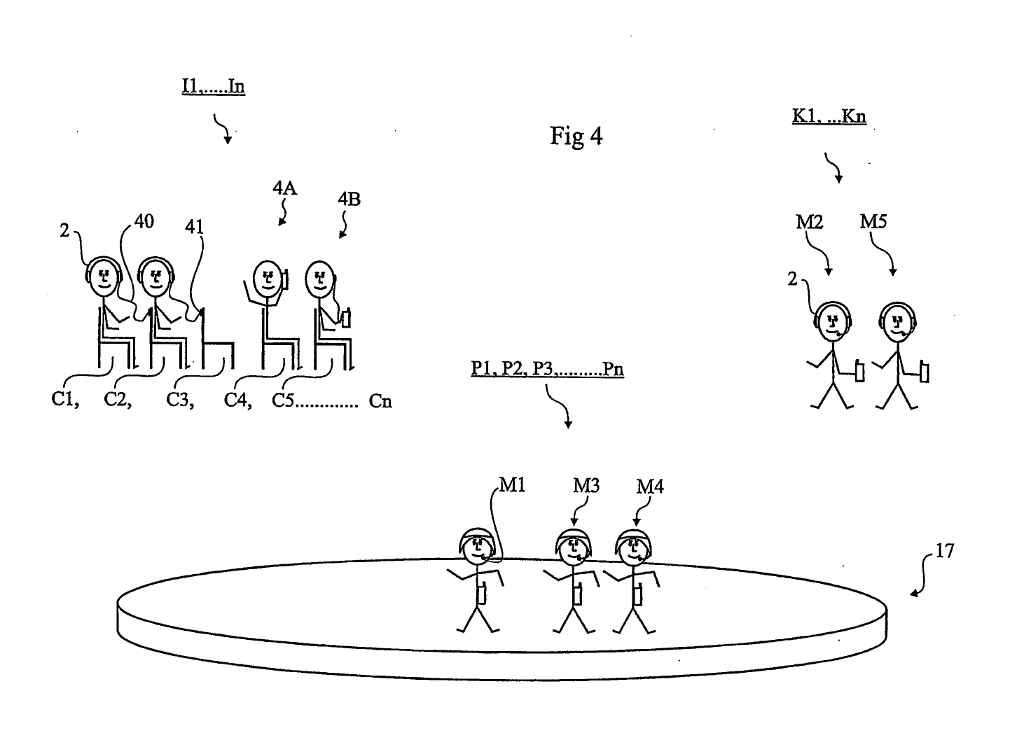

FIG. 3 shows an alternative in which only mobile technology is in question, when the televiewer 1 is sitting in a traveling car 16, but being able by mobile/wireless technology to receive a selectable audio stream via the telephone 4, and to listen to it in head phones 2 at the same time as the viewer 1 watches the chosen television program on a television set 3 in the car 16, in which case 3G technology may be used e.g. to transmit the video and audio package to the telephone that in turn transmits the video stream to the television set 3, by Bluetooth e.g.

FIG. 4 shows an additional modification according to the invention. Here, an arena 17, such as an ice-hockey rink, is schematically shown. A number of players P1-Pn are on the ice, carrying microphones M1, M3, M4. Among the spectators of the arena, there are viewers I1-In who wish to catch the audio of a certain chosen player P1, or possibly a chosen commentator K1-Kn also carrying microphones M2, M5. The basic principle for allowing this is similar to the one described above, by the viewer I1 selecting a code that is suitably shown in the arena, such as by being printed in the program or shown on an active screen inside the hall (not shown). The headphones can be obtained e.g. by payment of a deposit upon entering the hall, or they may be private head phones brought from home. By payment of a fee, associated for example with a specific seat C1-Cn, the viewer can plug in, e.g. via a connecting flex 40, at a connection unit 41 to a hi-fi system in the arena 17, in order to be able to listen to the player PI carrying the chosen microphone M1. Instead of using existing, fixed connections in the arena, it is of course also possible that the viewers instead make use of their cell phones 4A, 4B, in order to connect to the chosen audio source via the same, directly (see C4) or via a head set (see C5) e.g., according to what has been described above. It is obvious that in the same way as in connection with the interactive watching of television 3, an arena can also provide the viewers, if they so desire, with the possibility during the match to switch audio sources, for example by deciding already beforehand, in connection with the buying of a ticket, if you want to listen to a first player during the first period, a second player during the second period, and a commentator during the third period, or by being completely flexible in choice of the audio source to listen to and also for how long you want to listen to it. At use of cell phones 4A, 4B, a flexible possibility exists to let the cell phone operator register the exact selections made and for how long these are active, in order e.g. to be able to arrange for payment for the service via the ordinary telephone bill.

The invention is not limited to the above described, but can be varied within the scope of the appended claims. It is realised e.g. that most of the communication systems existing today, such as GSM, WDMA, 3G, fixed network, broadband etc., are well suited to be used in connection with the invention, after suitable adaptations. Of course, it is realised that the term “television set” shall be interpreted in its full sense in connection with the invention, i.e. a broad interpretation of the term “television”comprising all kinds of monitors/terminals in order to be able to watch a picture on a display, where the display may belong to an ordinary personal computer. It is realized that the invention, in its broadest sense, must not at all be connected to a simultaneous visual observation, i.e. also an interactive attendance to a performance by only taking in a chosen audio/sound flow, is an evident application within the scope of the invention. It is then realised that the term “audience” must be interpreted broadly and also include an audience which only takes in the sound flow, i.e. only one listener. An example of such an application according to the invention is to take in a desired performance/piece of information in a flexible manner (from a given position or person), the time of which cannot be determined in advance. A tangible example may be a person interested in trotting, who wants direct information from certain runs from a certain trotting track. Such a trotting race lasts several hours, and you can never exactly predict when each run will start. By using e.g. the cell phone as source of receipt for the information forwarded in real time (e.g. a reporter attending the trotting track) for the respective run when it is performed on the trotting track, an individual can get direct information in real time. Practically, this could be realised such that the individual in advance calls a known (advertised) cell phone number, or sends a certain code by SMS (see certain code according to claim 1) which has been registered with a distributor/service provider who has the possibility in real time to send said sound flow parallelly to several receivers. Then a confirmation is made in some type of a booking system that exactly that individual wants a specifically chosen sound flow to a certain cell phone. Naturally, the order as such may be placed through contact with an telephone operator, who afterwards in some suitable manner acknowledges the order, e.g. by SMS. The payment may be made in many different ways, as has already been described above (and also additional alternatives below), i.e. in accordance with many different flexible available alternatives (e.g. customer number, credit card, SIM-card, etc). Suitably, some kind of a validation should be included, i.e. some kind of double confirmation from the ordering individual that he really wants to buy the ordered service. The ordering individual may then make sure to be notified by cell phone of the ordered sound flow, wherever he is, e.g. if he sits in his car, in such a manner that the service distributor in a manner known per see pushes the sound flow into the cell phone, which can then be heard in the hands-free apparatus of the car. The ordering individual will thus in this way be notified in real time of all trotting runs ordered without himself needing to have any type of control of either time or place in order to simply and safely take part of the desired performance (in this case a trotting race).

It is also realised that a variety of forms of payment can be used to administer the interactive services according to the invention, such as advance payment, in principle in accordance with the cash card principle, meaning that you can connect for a predetermined time period, or that a certain fee is paid in advance for a certain desired audio source, or that in accordance with existing systems for e.g. parking services you require some type of registration unit that is paid for after use of the service to the extent corresponding to that registered in a registration unit etc. It is also possible to have cash payment or credit card payment systems, according to the principles of cash-operated machines e.g. It is furthermore realised that the cost for connecting to different types of microphones can be differentiated, e.g. such that it costs more per time unit to listen to the more popular players of a team, than to others. It is furthermore realised that in certain cases, it may be beneficial to use some specific equipment in order to choose a selectable audio source, such as a touch sensitive television screen enabling activation of a selection directly on the screen.

1-18. (canceled)

19. A method of providing selectable interactivity for a viewer watching a show, whereby the viewer can choose a position or person from which the viewer will experience audio from the ongoing show, wherein the viewer is informed of a given code (K1) arranged by a certain activity to provide said selectable audio from the show.

20. A method according to claim 19, wherein said viewer is a televiewer, and that said show is a television program on a television set.

21. A method according to claim 20, wherein said code (K1) is presented to the televiewer on the television screen.

22. A method according to claim 21, wherein said code (K1) is presented to the teleview on the television screen simultaneously with the broadcasting of the television program for which the selectability exists.

23. A method according to claim 19, wherein said code (K1) is arranged to be communicated to an ordering unit via telephone.

24. A method according to claim 23, wherein said code (K1 ) is a telephone number.

25. A method according to claim 1, wherein a plurality of such selectable codes (K1, . . . Kn) are shown, in order to provide selectability of different specific audio choices.

26. A method according to claim 1, wherein said selectable service is associated with a time-dependent cost.

27. A method according to claim 1, wherein said selectable service is associated with a minute per minute cost.

28. A method according to claim 1, wherein at least one of said codes (K1) is dedicated a given individual who partakes in the show.

29. A method according to claim 1, wherein at least one code (K2) is dedicated at least one given position associated with the show.

30. A system for providing selectable interactivity for a viewer watching a show, whereby the viewer can choose a position or person from which the viewer will experience audio from the ongoing show, wherein information means are included in the system and arranged to provide the viewer with information of a given code by which activation of communication means is achieved in order to obtain said selectable audio from the show.

31. A system according to claim 30, wherein said viewer is a televiewer, and that said show is a television program on a television set.

32. A system according to claim 31, wherein said code (K1) is presented to the televiewer on the television screen.

33. A system according to claim 31, wherein said code (K1) is presented to the televiewer on the television screen simultaneously with the broadcasting of the television program for which the selectability exists.

34. A system according to claim 30, wherein said code (K1) is arranged to be communicated to an ordering unit via telephone.

35. A system according to claim 34, wherein said code (K1) is telephone number.

36. A system according to claims 30, wherein a plurality of such selectable codes (K1, . . . Kn) are arranged, in order to provide multiple choice selectability for different specific audio sources.

37. A system according to claim 30, wherein the system comprises a time registering module arranged to create payment service in dependence of utilised time.

38. A system according to claim 30, wherein at least one of said codes (K1) is dedicated a given individual who partakes in the show.

39. A system according to claim 30, wherein at least one code (K2) is dedicated at least one given position associated with the show.
